(19) United States
(12) Patent Application Publication
(10) Pub. No.: US 2015/0290838 A1
(43) Pub. Date: Oct. 15, 2015

(54) AUTOMATIC SAWING MACHINE FOR CUTTING STONES AND MATERIALS OF IRREGULAR SHAPE AND DIFFERENT SIZES

(71) Applicant: Mariano LOVATO, Vestenanova (IT)

(72) Inventor: Mariano Lovato, Vestenanova (VR) (IT)

(21) Appl. No.: 14/436,818

(22) PCT Filed: Oct. 17, 2013
(86) PCT No.: PCT/IT2013/000290

§ 371 Date: Apr. 17, 2015

(30) Foreign Application Priority Data
Oct. 19, 2012 (IT) VI2012A000277

(51) Int. Cl. B28D 1/04; B23D 45/14; B28D 7/04

(52) U.S. Cl. CPC B28D 1/048; B28D 1/046; B28D 7/04; B23D 45/146

(57) ABSTRACT

An automatic sawing machine (1) for cutting stones and materials of irregular shape and different sizes, having at least one frame (2, 4) for supporting at least two longitudinal conveyor elements (5, 6) with at least two respective conveyor belts (7, 8), which are perpendicular one each other, so as to provide a V-shaped channel (11); the conveyor belts (7, 8) being able to support and to carry one or more stones and/or other similar materials, such as marble, porphyry, granite, etc., from a first input terminal (14) to a second output terminal (15) of the machine (1) and each conveyor belt (7, 8) is also associated with a cutting diamond disk (12, 13), which is placed parallel to the respective conveyor belt (7, 8) and which is able to cut angular or flat portions of the stones.

The present invention generally discloses an automatic sawing machine for cutting stones and materials of irregular shape and different sizes, particularly for angular coatings.

More particularly, the invention relates to an automatic sawing machine, which is able to continuously cut stones or other materials (such as marble blocks, porphyry, granite and similar materials) of irregular shape and variable sizes, such as angular portions to make angular coatings and/or linear portions.

Thus, the cut stone, while keeping unaltered its natural shape, has a smooth surface that makes easy to put it on any linear and/or angular surface.

Furthermore, an automatic thickness compensation system allows a continuous cutting even of the scraps coming, for example, from the quarries, such as stones and/or slabs.

The technical problem arising from mechanically sawing, by means of an automatic sawing machine, a block or stone made of marble, porphyry, granite or similar materials, is caused from the irregular shape and the extremely variable sizes of the block.

The known sawing machines, once adjusted the shape and the sizes of the blocks to be cut, work with high efficiency and productivity, however, they do not allow to obtain clean and accurate cuts and also they are able to work only pieces having similar form and sizes.

Otherwise, it is necessary to manually adjust each time the size of the piece, with obvious drawbacks in the production of said pieces.

Therefore, an object of the present invention is to obviate the above mentioned drawbacks of the prior art and, in particular, to provide an automatic sawing machine for cutting stones and materials of irregular shape and different sizes, which makes sharp and accurate cuts for any type of material to be treated and even for smooth and polished products and/or objects.

Another object of the present invention is to provide an automatic sawing machine for cutting stones and materials of irregular shape and different sizes, which is able to compensate the thickness differences of the materials and pieces to be treated, without having to perform any manual adjustment.

Another object of the present invention is to provide an automatic sawing machine for cutting stones and materials of irregular shape and different sizes with high productivity and reliability.

A further object of the invention is to provide an automatic sawing machine for cutting stones and materials of irregular shape and different sizes, which is able to cut marble blocks or stones and/or other materials, such as granite or porphyry.

These objects, according to the present invention, are achieved by an automatic sawing machine for cutting stones and materials of irregular shape and different sizes according to the enclosed claim 1; further technical features are disclosed in the subsequent dependent claims.

Advantageously, the machine is able to continuously work marble blocks or stones by using at least one tool, and preferably by using two or more diamond disks, which are mounted from opposite sides and which are vertically adjustable; the machine can also be used for cutting corner portions and/or flat portions (for angular and/or linear coatings of buildings in general), even made of other materials, such as granite or porphyry, by using different diamond disks.

The invention is also applicable to known machines, simply by substituting few pieces, and it can be easily adaptable to different types of stones or blocks.

Moreover, an automatic thickness compensation system allows to continuously cut scraps coming, for example, from the quarries, so as to fully exploit wastes.

Furthermore, the machine according to the invention allows to carry out a waste recycling, an environmental protection, the energy and raw material saving, also being able to provide for an accurate laying of said stones and blocks.

Also, as the sawing machine of the invention uses sliced material and stones that are normally destined for landfills, said machine is able to cut the stone so as to have a perfectly smooth surface, thus requiring not much glue, with advantages for the installer's health and for time and material savings.

The machine is equipped with motors controlled by inverters and having diamond disks, so as to adjust the power consumption, without dissipation and with energy saving.

The above mentioned objects and advantages, as well as others that will appear hereinafter, will become more clear from the following description, which relates to a preferred embodiment of the automatic sawing machine for cutting stones and materials of irregular shape and different sizes, which is the object of the present invention, and with reference to the enclosed drawings, in which:

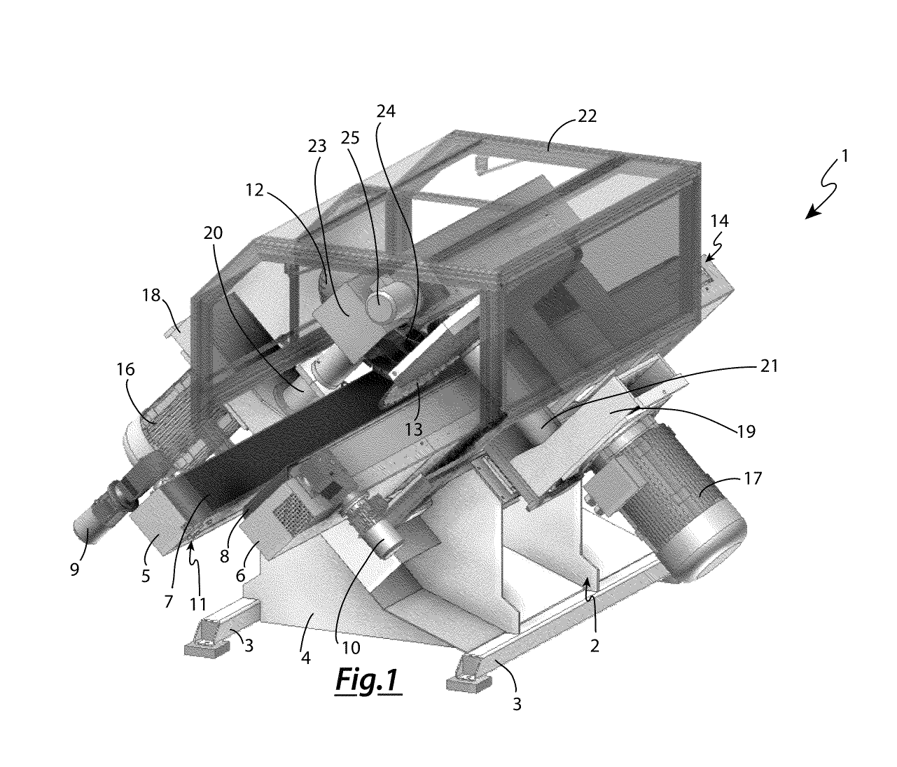

FIG. 1 is a perspective view of an automatic sawing machine for cutting stones and materials of irregular shape and different sizes, according to the invention;

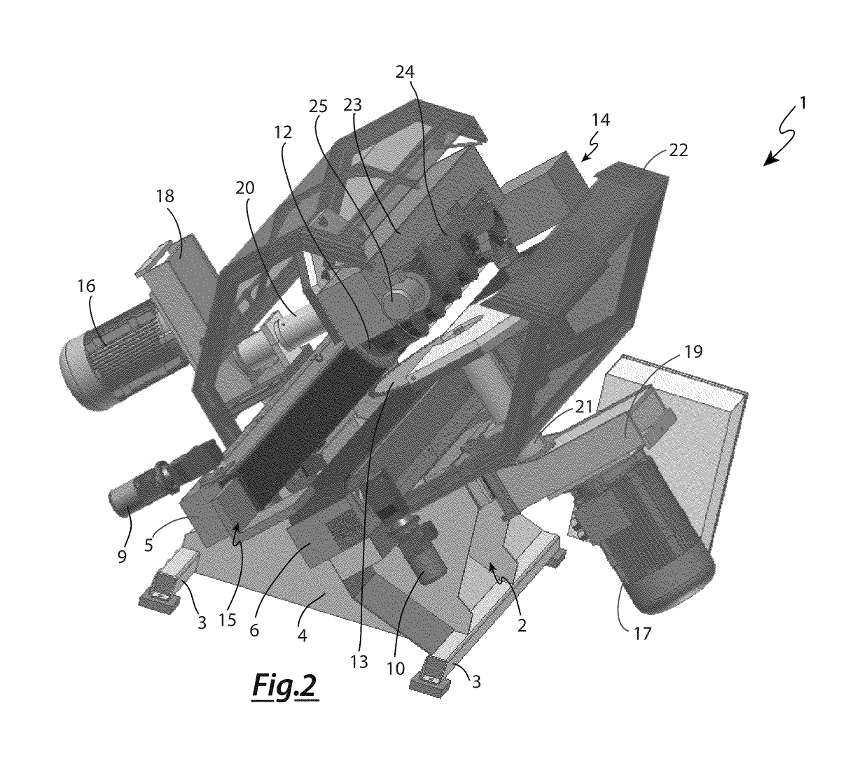

FIG. 2 is a partially exploded perspective view of the automatic sawing machine of FIG. 1, according to the present invention;

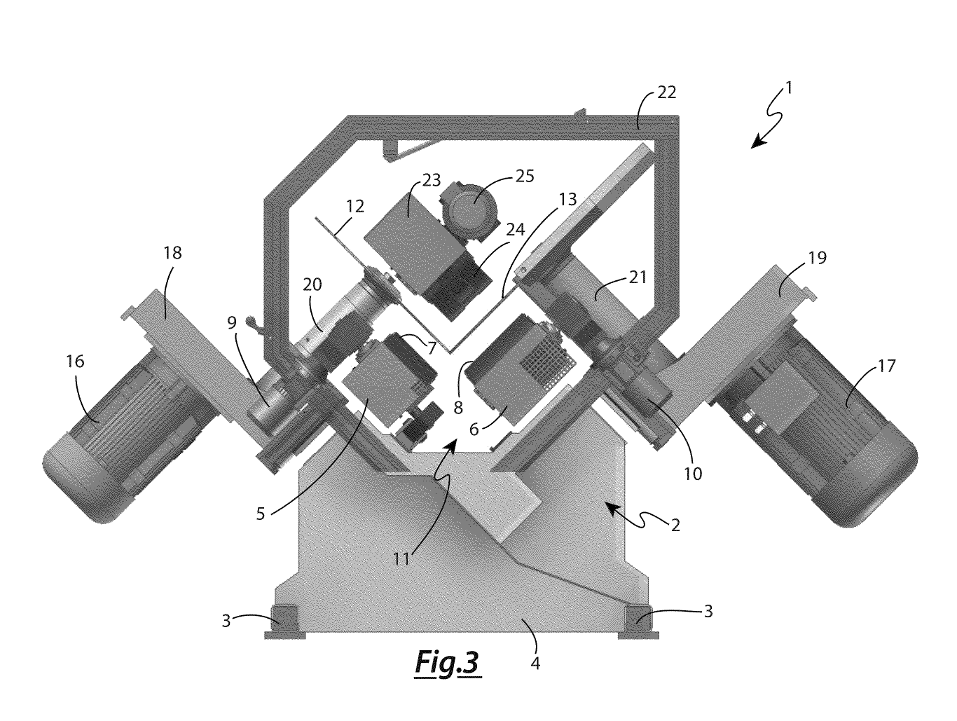

FIG. 3 is a front view of the automatic sawing machine of FIG. 1, according to the present invention;

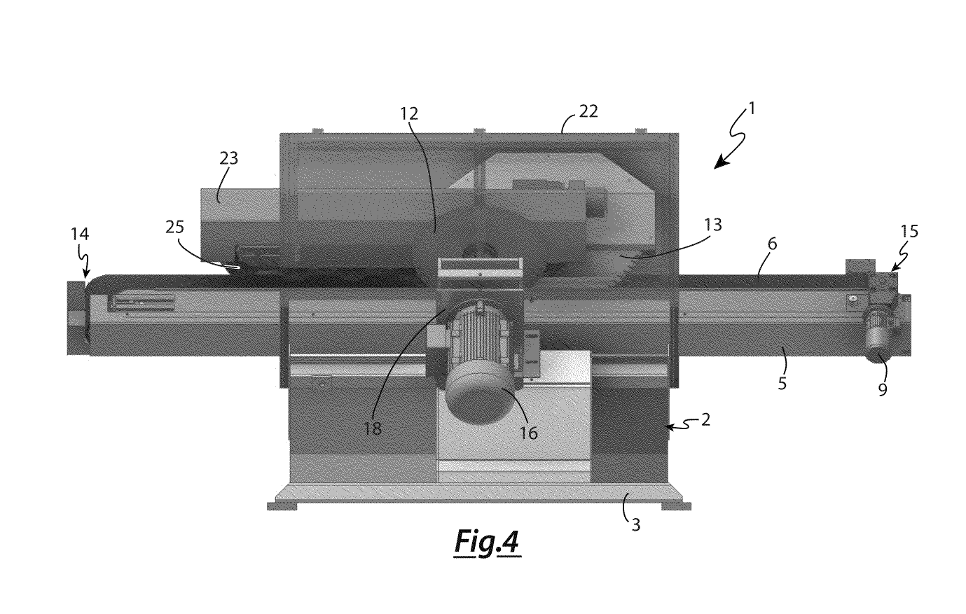

FIG. 4 is a side view of the automatic sawing machine of FIG. 1, according to the present invention;

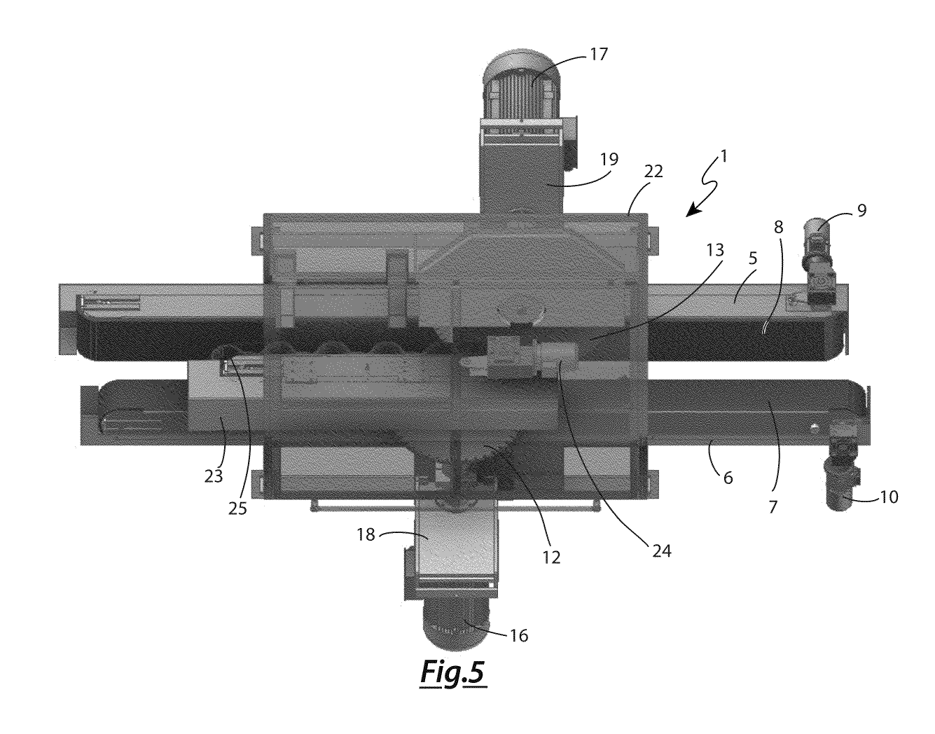

FIG. 5 is a top plan view of the automatic sawing machine of FIG. 1, according to the present invention;

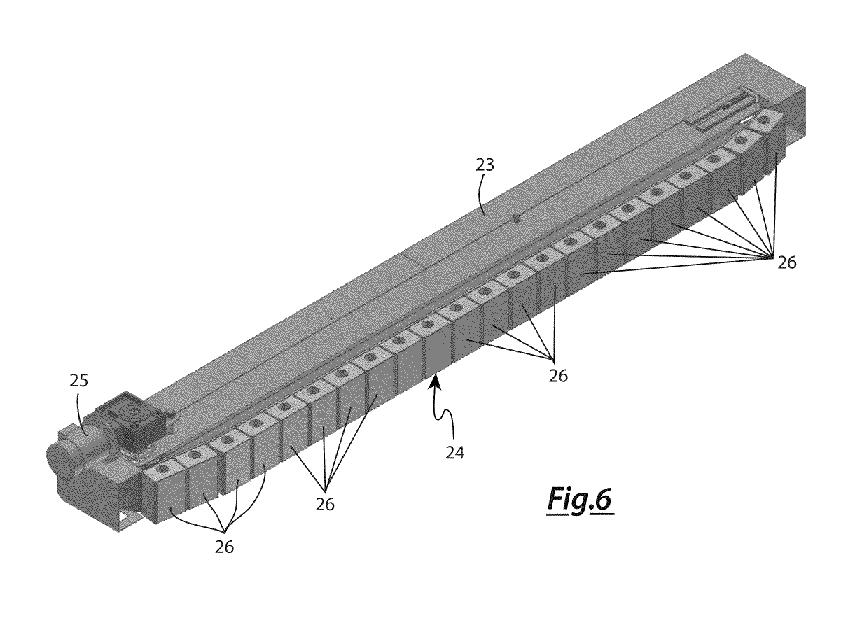

FIG. 6 is a perspective view of a first embodiment of a conveyor belt used in the automatic sawing machine of FIG. 1, according to the present invention;

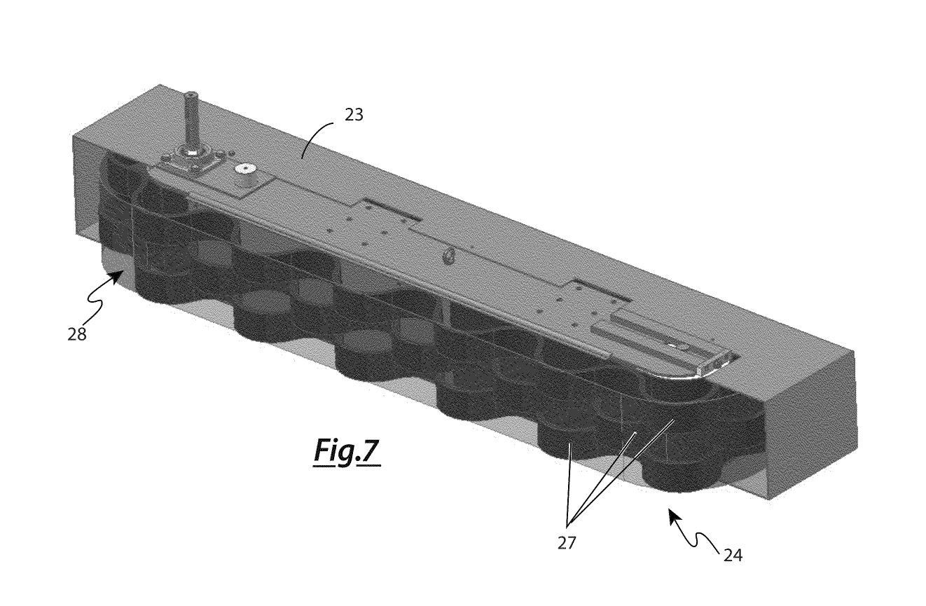

FIG. 7 is a perspective view of a second embodiment of a conveyor belt used in the automatic sawing machine of FIG. 1, according to the present invention.

With particular reference to the above mentioned figures from 1 to 5, the automatic sawing machine 1 according to the present invention comprises a frame 2 equipped with adjustable pedestals 3 and with a support structure 4, which is connected to two longitudinal carriage elements 5, 6 placed perpendicularly between them and preferably arranged so that each element is placed with an angle of 45° with respect to the support surface of the pedestals 3; it is clear that said angle can vary by rotating the arrangement of the elements 5, 6 (which are always perpendicular one to each other), up to values close to 15-20°.

Relative conveyor belts 7, 8 are associated with said longitudinal elements 5, 6, which are provided along the support element 4 of the frame 2; said conveyor belts 7, 8 are also perpendicular one to each other and they are placed parallel to the respective longitudinal elements 5, 6, thus forming a V-shaped channel (indicated with 11 in the enclosed figures).

Each conveyor belt 7, 8 is suitably driven by a respective electric or induction motor 9, 10, even if it is possible to use a single drive motor and a return element.

Moreover, the drive motors 9, 10 are electronically controlled, so that the speeds of the conveyor belts 7, 8 are suitably adjusted and they are substantially the same during the cutting operations.

With reference to the enclosed figures from 1 to 5, the machine according to the invention also includes two diamond disks 12, 13, which are employed for cutting workpieces made of stone, marble, granite, porphyry, etc. and generally water-cooled, which are fixed to the frame 2 of the machine 1 and which are associated with the respective carriage elements 5, 6.

In particular, the diamond cutting disk 12 is arranged above and parallel to the belt 7 of the longitudinal carriage element 5, while the diamond disk 13 is placed above and parallel to the belt 8 of the longitudinal carriage element 6.

Furthermore, the disks 12, 13 are perpendicular to each other and identify a V-shaped channel, as well as the belts 7, 8 of the respective carriage elements 5, 6.

In particular, the diamond disks 12, 13 are placed staggered along the shaped channel 11 of the conveyor belts 7, 8, so that a first disk 12 is positioned closer to the input terminal or entry 14 of the machine 1, and a second disk 13 is placed nearest to the output terminal or exit 15 of the machine 1.

Furthermore, according to a preferred embodiment of the invention, each diamond cutting disk 12, 13 is driven by a respective motor 16, 17, for example an electric or induction-type motor, which is fixed to a support structure 18, 19 of a respective spindle 20, 21.

The first diamond disk 12 is able to cut a first side of a block made of stone or other material, while the second diamond disk 13 is able to cut the side which is perpendicular to said first side, as the block moves forward inside the shaped channel 11 formed by the conveyor belts 7, 8 of the sawing machine 1 from the entry 14 to the exit 15.

The support structure 18 may shift with respect to the frame 2 of the machine 1 and thus the first diamond disk 12 is moved towards or away from the relative conveyor belt 7, in order to adjust the cutting thickness; said cutting disk 12 can also be moved towards or away from the conveyor belt 8, so as to adjust the height of the block to be cut.

Similarly, the same adjustments can be made by moving the second diamond cutting disk 13 towards or away from the conveyor belts 7 and 8. The V-shaped arrangement of the longitudinal carriage elements 5, 6 constitutes an extremely stable seat for housing the stone block to be cut. In fact, the machine 1 takes advantage from the force of gravity to maintain stable the block once said block is moved from the belts 7, 8 inside the cover 22 which contains the central portion of the longitudinal carriage elements 5, 6, as well as the cutting disks 12, 13.

The arrangement of the cutting disks 12, 13 with respect to the conveyor belts 7, 8 also makes easier the adjustments of the height and thickness of the block's sides.

Although the sawing machine 1 of the present invention has been described as usable mainly for cutting of angular blocks, said machine 1 can be similarly used for cutting flat workpieces according to a horizontal direction.

For example, it is possible to cut said workpieces by removing one of said diamond disks 12 or 13 and by adjusting the positioning of the other disk 13 or 12 according to the cutting sizes, thus keeping an extremely stable positioning of the workpiece on the V-shaped support surface constituted by the shaped channel 11.

According to the present invention, a further longitudinal carriage element 23 is placed within the cover 22 and above the diamond cutting disks 12, 13; moreover, a pressing tape 24 is associated to the carriage element 23 and is placed on the opposite side and parallel to one of the longitudinal carriage elements 5 or 6 (and therefore perpendicular to the other longitudinal carriage element 6 or 5).

Said carriage element 23 is preferably placed along a portion within the cover 22 and, in particular, between the two diamond disks 12 and 13, said element 23 is also fixed to the frame 2 of the sawing machine 1 and is equipped with a separate motor 25, which is able to drive the pressing tape 24.

The pressing tape 24, which is thus placed on the opposite side with respect to the lower carriage belts 7 and 8 supporting the workpiece, allows to further maintain stable the piece and to get even more sharp and accurate cuts.

The pressing tape 24 of the carriage element 23 can be made by means of single tracks 26 alongside one another (as shown in the enclosed FIG. 6) or it can be constituted by one or more corrugated and substantially sinusoidal foils 27, which are enclosed by an external containment tape 28 (as shown in the enclosed FIG. 7).

In the latter case, the corrugated foils 27 are preferably made of harmonic steel and are adapted to compensate for different thicknesses of the various workpieces.

According to other embodiments of the invention, in order to perform, as described above, compensation for differences of the workpieces' shape, each pressing tape 24 may have a plurality of pneumatic cylinders, adjacent to each other along the direction of movement of the workpiece within the machine 1 and arranged so as to be substantially perpendicular to said direction; thus, the pneumatic cylinders push the pressing tape 24 outwards, i.e. towards the workpiece to maintain stable and in position.

Moreover, the pressing tape 24 may have a shaped mat, which has a plurality of fins arranged perpendicular to said tape and at the same distance one from each other; thus, the elasticity of the fins, together or less with the use of said pneumatic cylinders, allows the pressing tape 24 to adapt to the irregular shapes and to the different profiles of the workpieces which are inserted in the sawing machine 1.

In further embodiments of the invention, the pressing tape 24 can include a spongy elastic mat, for example with closed cells, which is externally covered by a wear-resistant material; this embodiment is particularly effective when workpieces which are particularly smooth and without sharp edges or protrusions, such as river pebbles, are inserted in the sawing machine 1.

In fact, the pressure exerted by the tape 24 on the workpiece, which is stably positioned within the shaped channel 11 of the machine 1, causes an accurate and stable driving of the workpiece along the whole path inside the machine 1, thus allowing the diamond disks 12, 13 to make sharp cuts, as well as smooth and accurate, on the walls of the workpiece. Once the cutting phase is finished, the pressure on the workpiece is gradually decreased and the cut portions of the workpiece are automatically removed by means of the diamond cutting disks 12, 13.

The technical characteristics of the automatic sawing machine for cutting stones and materials of irregular shape and different sizes, which is the object of the present invention, are clear from the above description, as well as its advantages are also clear.

Finally, it is clear that other variations may be made to the automatic sawing machine of the invention, without departing from the principles of novelty contained in the appended claims, as it is clear that in the practical implementation of the invention, materials, shapes and dimensions of the technical features may be any according to requirements and they can be replaced with other technically equivalent.

1. Automatic sawing machine (1) for cutting stones and materials of irregular shape and different sizes, comprising at least one frame (2, 4) for supporting at least two longitudinal conveyor or carriage elements (5, 6) with at least two respective conveyor belts (7, 8), which are perpendicular one each other, so as to provide a V-shaped channel (11), said conveyor belts (7, 8) being able to support and to carry one or more stones and/or other similar materials, such as marble, porphyry, granite, etc., from a first input terminal (14) to a second output terminal (15) of the machine (1), each conveyor belt (7, 8) being also associated with at least one cutting diamond disk (12, 13), which is placed parallel to the respective conveyor belt (7, 8) and which is able to cut angular or flat portions of the stones, characterized in that said sawing machine (1) has at least one third longitudinal conveyor or carriage element (23), associated with at least one pressing tape (24), which is arranged above said cutting diamond disks (12, 13) and which is opposed to said at least two longitudinal elements (5, 6).

2. Automatic sawing machine (1) according to claim 1, characterized in that each of said longitudinal elements (5, 6) are placed with an angle of between 15° and 20° or an angle of 45° with respect to a support surface of said automatic sawing machine (1).

3. Automatic sawing machine (1) according to claim 1, characterized in that each of said conveyor belts (7, 8) is actuated by a respective motor (9, 10) or said conveyor belts (7, 8) are driven by a single motor and a transmission.

4. Automatic sawing machine (1) according to claim 1, characterized in that said cutting diamond disks (12, 13) are perpendicular one each other, thus identifying a V-shaped channel.

5. Automatic sawing machine (1) according to claim 1, characterized in that said cutting diamond disks (12, 13) are offset along said shaped channel (11) of the conveyor belts (7, 8), so that a first cutting disk (12) is closest to said input terminal (14) of the machine (1) and a second cutting disc (13) is closest to said output terminal (15) of the machine (1).

6. Automatic sawing machine (1) according to claim 1, characterized in that each cutting diamond disk (12, 13) is actuated by a respective motor (16, 17), which is connected to a respective spindle (20, 21).

7. Automatic sawing machine (1) according to claim 1, characterized in that at least one of said cutting diamond disks (12, 13) is movable towards or away from at least one of said conveyor belts (7, 8), in order to adjust the cutting thickness and/or the cutting height of the stones.

8. Automatic sawing machine (1) according to claim 1, characterized in that said pressing tape (24) is parallel to one of said at least two longitudinal elements (5, 6).

9. Automatic sawing machine (1) according to claim 1, characterized in that said third longitudinal element (23) is equipped with an independent motor (25), which provides actuation of said pressing tape (24).

10. Automatic sawing machine (1) according to claim 1, characterized in that said pressing tape (24) is constituted by a plurality of tracks (26), which are joined to one another, or by one or more corrugated plates or foils (27), which are enclosed within an outer cover (28), or by a shaped mat with fins and/or by a spongy elastic mat, so that said pressing tape (24) is able to process stones of irregular shapes and different sizes and/or is able to compensate different thicknesses of said stones.
